(19) United States
(12) Patent Application Publication
(10) Pub. No.: US 2009/0120995 A1
(43) Pub. Date: May 14, 2009

(54) FRICTION STIR WELD TOOLS, METHODS OF MANUFACTURING SUCH TOOLS, AND METHODS OF THIN SHEET BONDING USING SUCH TOOLS

(75) Inventors: N. Pat Hallinan, Pocatello, ID (US); Douglas E. Burkes, Idaho Falls, ID (US)

Correspondence Address: TraskBritt / Battelle Energy Alliance, LLC, PO Box 2550, Salt Lake City, UT, 84110, US

(73) Assignee: Battelle Energy Alliance, LLC, Idaho Falls, ID (US)

(21) Appl. No.: 11/936,976

(22) Filed: Nov. 8, 2007

(51) Int. Cl. B23K 20/12; B23K 31/02; B23P 17/00

(52) U.S. Cl. 228/2.3; 228/112.1; 29/592

(57) ABSTRACT

Friction stir weld tools configured to bond or laminate thin sheets. Friction stir weld tools have a first shoulder, a pin extending from a friction surface of the first shoulder, and a second shoulder. In some embodiments, the second shoulder is secured at least partially around the first shoulder and includes an engagement surface longitudinally recessed with respect to the friction surface of the first shoulder. In additional embodiments, the second shoulder is proximate the first shoulder and rotationally fixed. In yet additional embodiments, the pin has a diameter that is greater than the height of the pin and the second shoulder is secured at least partially around the first shoulder. Methods include manufacturing such friction stir weld tools. Methods include friction stir welding using such tools.

### GOVERNMENT RIGHTS

The United States Government has certain rights in this invention pursuant to Contract No. DE-AC07-05-ID14517 between the United States Department of Energy and Battelle Energy Alliance, LLC.

### FIELD OF THE INVENTION

The present invention relates generally to friction stir welding. More particularly, the present invention relates to friction stir weld tools for thin metal bonding and methods of manufacturing and thin sheet bonding using such tools.

### BACKGROUND

Friction stir welding is a solid state mechanical bonding process developed primarily for welding aluminum and aluminum alloys which are difficult to weld using conventional welding techniques. Friction stir welding is described in U.S. Pat. No. 5,460,317 to Thomas et al., the entire disclosure of which is incorporated herein by reference.

Friction stir welding has conventionally been used to weld butt joints, corner joints, and lap joints; however, friction stir welding is currently being investigated as a method to laminate or bond thin sheets or foils. One application in which laminating or bonding thin sheets or foils using friction stir welding is particularly promising is the formation of monolithic fuel plates for nuclear reactors. FIGS. 1A-D illustrate one method of using a conventional friction stir weld tool to laminate or bond thin metal sheets to form a monolithic fuel plate.

As shown in FIG. 1A, a preassembled monolithic fuel plate 10 may comprise a fuel foil 16 disposed between two thin metal sheets 12, 14. The fuel foil 16 may comprise uranium or a uranium alloy, such as for example uranium-molybdenum. The thin metal sheets 12, 14 may comprise aluminum or an aluminum alloy. The thickness of the preassembled fuel plate 10, as shown in FIG. 1A, may be relatively thin compared to other materials conventionally welded using friction stir welding. For example, the preassembled fuel plate 10 may be approximately 1.47 millimeters thick.

As shown in FIG. 1B, friction stir welding employs a rotating friction stir weld tool 20 comprising a small diameter probe or pin 22 mounted concentrically below a shoulder 26. As shown in FIG. 1C, a friction stir welding machine or conventional milling machine (not shown) is used to plunge the pin 22 into the surface of the upper thin metal sheet 12 until the shoulder 26 rests upon the surface of the upper thin metal sheet 12. The friction stir weld tool 20, including both the pin 22 and the shoulder 26, is rotated to create heat and pressure. The shoulder 26 serves to control the depth of the weld, to keep the process material from migrating away from the process area, and to provide added heat and pressure.

The heat and pressure created by the mechanical friction of the rotating tool 20 plasticizes (softens) the metal in the region near the pin 22. As shown in FIG. 1C, the tool 20 is moved in a direction 28 along the surface of the upper sheet 12 over the interface 24 between the sheets 12, 14 and the fuel foil 16 to create a region of plasticized material. As the pin 22 rotates and moves along the interface 24, the metal near the front of the pin 22 is plasticized and extruded behind the pin 22 while undergoing a mechanical stirring and forging action caused by the pin surface profile. The stirred, plasticized material forms a weld 30 (FIG. 1D) between the thin metal sheets 12, 14 and between the upper thin metal sheet 12 and the fuel foil 16.

The plasticized material is confined from above by the pressure exerted on the upper thin metal sheet 12 by the shoulder 26. As shown in FIGS. 1C and 1D, the pin 22 is kept slightly above the interface 24 to avoid disrupting the fuel foil 16 and to avoid stirring the fuel foil 16 into the upper thin metal sheet 12.

The friction stir welding process described above may be repeated with overlapping welds to cover the entire surface area of the upper thin metal sheet 12 in order to laminate or bond the faces of the thin metal sheets 12, 14 together and to bond the upper thin metal sheet 12 to the fuel foil 16. Optionally, the fuel plate 10 may be turned over and the friction stir welding process, as described above, may be repeated to bond the fuel foil 16 to the lower thin metal sheet 14.

The process of using friction stir welding to form a fuel plate may leave a scalloped finish on the surface of the fuel plate 10, making it unsuitable for use in a reactor without further processing. The surface of the fuel plate 10 may be smoothed using methods known by one of ordinary skill in the art, such as mechanical polishing.

The process described above may be slightly modified to bond or laminate thin metal sheets in applications other than fuel plates. While the use of friction stir welding to bond or laminate thin metal sheets or foils, and particularly to form fuel plates, is promising and has been used with some degree of success, the thickness of the materials being bonded or more specifically lack thereof, may cause several defects in the weld. In particular, there may be inconsistent bonding between dissimilar metals and the metal sheets may buckle during the friction stir welding process. Furthermore, the thin metal sheets 12, 14 may severely warp during the friction stir welding process and the shoulder 26 of the friction stir weld tool 10 may tear the metal sheets 12, 14 as it passes over any warped portions. In the processing of fuel plates, these defects may cause serious problems, such as torn cladding over the fuel zone resulting in exposed fuel foils. These defects in bonding thin metal sheets may be largely due to the use of conventional friction stir weld tools that are intended for welding thicker material utilizing a pin that penetrates the entire thickness of the material.

### BRIEF SUMMARY OF THE INVENTION

In some embodiments, the present invention includes friction stir weld tools having a first shoulder, a pin extending from a friction surface of the first shoulder, and a second shoulder secured at least partially around the first shoulder. The second shoulder comprises an engagement surface that may be longitudinally recessed with respect to the friction surface of the first shoulder.

In additional embodiments, the present invention includes friction stir weld tools including a first shoulder, a pin extending from a friction surface of the first shoulder, and a second rotationally fixed shoulder proximate the first shoulder.

In other embodiments, the present invention includes friction stir weld tools including a first shoulder, a pin extending from a friction surface of the first shoulder, and a second shoulder secured at least partially around the first shoulder. The pin has a diameter that is greater than the height of the pin.

In yet additional embodiments, the present invention includes methods of manufacturing a friction stir weld tool by providing a first shoulder, securing a second shoulder at least partially around the first shoulder, and longitudinally recessing the second shoulder along a longitudinal axis of the friction stir weld tool relative to the first shoulder.

In yet further embodiments, the present invention includes methods of friction stir welding to bond overlapping first and at least a second thin sheets. The methods include inserting a pin of a friction stir weld tool into a surface of the first thin sheet, abutting a first shoulder of the friction stir weld tool against the surface of the first thin sheet, and offsetting a second shoulder of the friction stir weld tool from the surface of the first thin sheet. The methods further include rotationally driving the friction stir weld tool along an interface between the first and at least a second thin sheets and causing the second shoulder to first contact at least a portion of the first thin sheet when the at least a portion of the first thin sheet begins to warp.

### BRIEF DESCRIPTION OF THE SEVERAL VIEWS OF THE DRAWINGS

While the specification concludes with claims particularly pointing out and distinctly claiming that which is regarded as the present invention, the advantages of this invention may be more readily ascertained from the following detailed description of the invention when read in conjunction with the accompanying drawings in which:

FIGS. 1A-1D illustrate a conventional friction stir weld tool and an example of a friction stir welding process that may be used to bond thin metal sheets;

FIG. 2 is a longitudinal cross-sectional view of an embodiment of a friction stir weld tool of the present invention that includes a second shoulder rotatably secured at least partially around a first shoulder;

FIG. 3 is a longitudinal cross-sectional view of the friction stir weld tool shown in FIG. 2;

FIG. 4 is a plan view of the face of the friction stir weld tool shown in FIGS. 2 and 3;

FIGS. 5, 6, and 7 are plan views like that of FIG. 4 illustrating additional embodiments of friction stir weld tools of the present invention;

FIG. 8 is a longitudinal cross-sectional view of another embodiment of a friction stir weld tool of the present invention that includes a second shoulder secured to a shaft of the friction stir weld tool; and

FIG. 9 illustrates an embodiment of a friction stir welding method of the present invention that may be used to bond thin sheets.

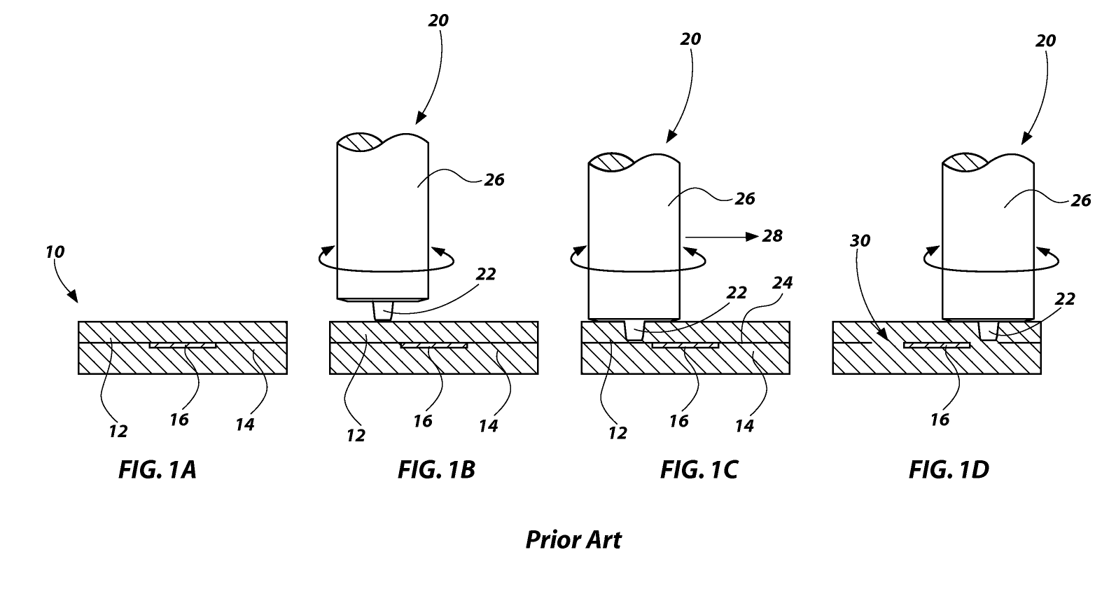

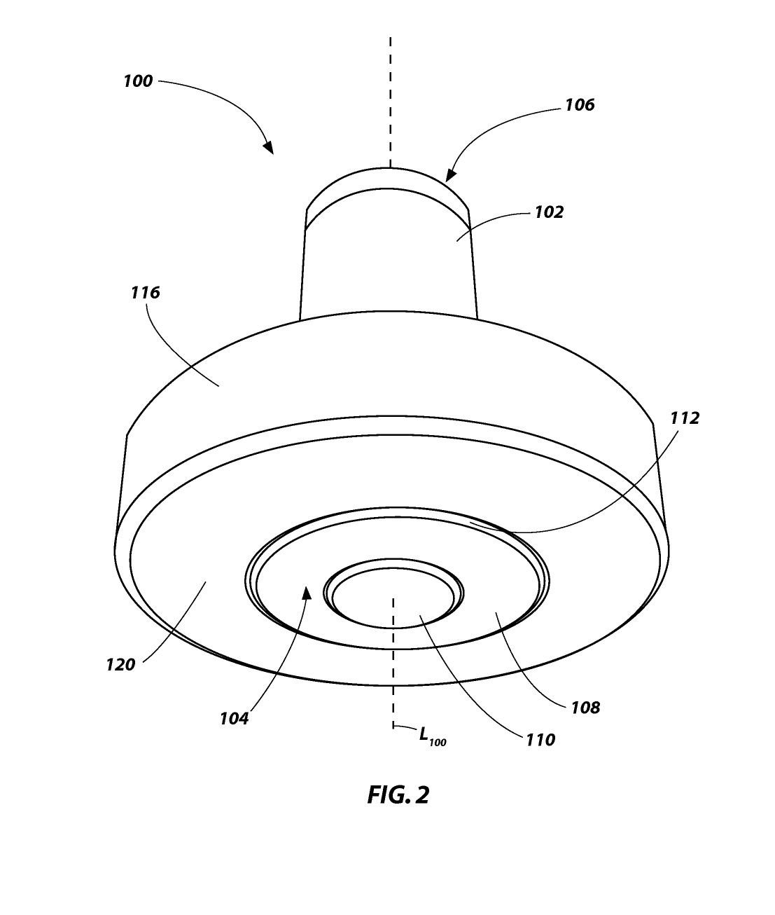

### DETAILED DESCRIPTION OF THE INVENTION

The illustrations presented herein are not meant to be actual views of any particular material, apparatus, system, or method, but are merely idealized representations which are employed to describe the present invention. Additionally, elements common between figures may retain the same numerical designation.

In view of the above, the inventors of the present invention have developed novel friction stir weld tools, in various embodiments, including a second shoulder mounted at least partially around a first shoulder that may rotate relative to the second shoulder. The second shoulder may suppress warping, buckling, and tearing of a workpiece during friction stir welding operations. The inventors of the present invention have additionally developed novel methods of manufacturing and using such tools, in various embodiments, to bond thin metal sheets. Such tools and methods are described below with reference to FIGS. 2-9.

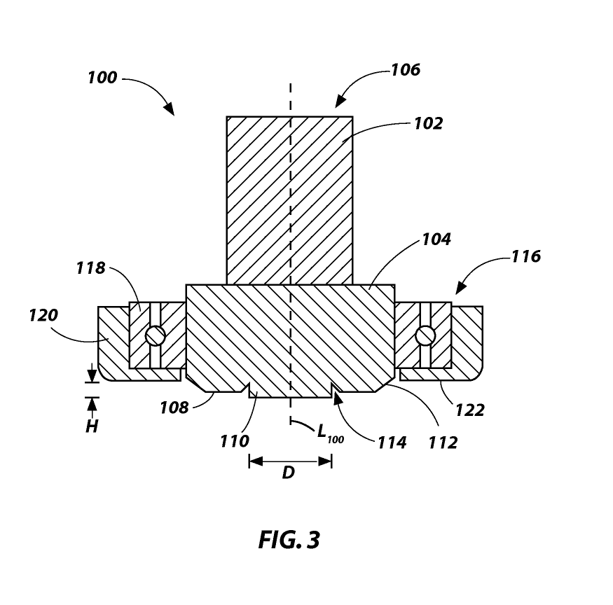

An embodiment of a friction stir weld tool 100 of the present invention is shown in a perspective view in FIG. 2 and in a longitudinal cross-sectional view in FIG. 3. As shown in FIGS. 2 and 3, the friction stir weld tool 100 may comprise a shank 102, a first shoulder 104 secured to a distal end of the shank 102, and a second shoulder 116 mounted at least partially around the first shoulder 104. A proximal end 106 of the shank 102 may be configured for attachment to a conventional friction stir weld machine (not shown). The term “friction stir weld machine,” as used herein, means any device capable of rotating the friction stir weld tool 100 about a longitudinal axis L₁₀₀ thereof, translating the friction stir weld tool 100 along a desired weld line, and providing a force generally in the axial direction of the shank 102 sufficient to plunge a pin 110 of the friction stir weld tool 100 into a workpiece. As non-limiting examples, a friction stir weld machine may include a fully automated and fully articulated robotic arm, a multi-axis machine tool, such as a computer numerical control machine (CNC machine), or a conventional milling machine.

As shown in FIG. 3, the first shoulder 104 is coaxially and non-rotatably secured to the shank 102. In other words, the first shoulder 104 and the shank 102 share a common axis of rotation L₁₀₀ and the first shoulder 104 does not rotate relative to the shank 102. In other embodiments, the first shoulder 104 may be integrally formed with the shank 102 as a single member.

The first shoulder 104 may comprise a friction surface 108 configured to abut against a surface of a workpiece when used in friction stir welding operations. The friction surface 108 comprises the distal surface of the first shoulder 104 opposite the end of the first shoulder 104 secured to the shank 102. In some embodiments, the friction surface 108 of the first shoulder 104 may extend in a direction generally perpendicular to and radially outward from a longitudinal axis L₁₀₀ of the friction stir weld tool 100. In other embodiments, the friction surface 108 may be tapered and extend in a direction generally upward towards the proximal end 106 of the shank 102 and generally radially outward from the longitudinal axis L₁₀₀ of the friction stir weld tool 100.

As discussed above and as is generally known in the art, the shoulder of a stir weld tool may be used to apply a confining pressure to the plasticized material of a workpiece and to provide added heat to the workpiece. The diameter of the first shoulder 104 and therefore the surface area of the friction surface 108 may be configured to control the area of pressure and amount of heat applied to a workpiece. In some embodiments, the diameter of the first shoulder 104 may be between about one and a half times and about four times the largest diameter of the pin 110. In other embodiments, the first shoulder 104 may be approximately two and a half times the largest diameter of the pin 110.

The friction surface 108 may be substantially planar. Additionally, as shown in FIGS. 2 and 3, the friction surface 108 may include surface geometry, such as a beveled edge 112 extending circumferentially around the friction surface 108 and a recessed portion 114 extending circumferentially around the pin 110. The recessed portion 114 may allow proper flow, mixing, and forging of plasticized material of a workpiece as it flows around the pin 110.

The probe or pin 110 may be mounted coaxially with the shank 102 and the first shoulder 104 and extend from the friction surface 108 of the first shoulder 104 in a direction generally perpendicular thereto. The pin 110 may comprise any of a wide variety of geometries and is shown herein as having a particular geometry as a non-limiting example to facilitate description of the present invention. The present invention contemplates pin geometries including, but not limited to, threaded, un-threaded, cylindrical, truncated cone, reverse truncated cone, and bossed pins and various combinations thereof.

Additionally as shown in FIG. 3, the pin 110 may have an outside diameter D and a height H. In some embodiments, the diameter D of the pin 110 may be larger than the height H of the pin 110. In other words, the measured length of the diameter D may be larger than the measured length of the height H. Furthermore, the height H may be configured so the pin 110 does not fully extend through an upper thin sheet when laminating or bonding it to a lower thin sheet.

As mentioned previously, the friction stir weld tool 100 may comprise a second shoulder 116 mounted at least partially around the first shoulder 104. As shown in FIG. 3, the second shoulder 116 may comprise a collar 120. The collar 120 may comprise an engagement surface 122. The engagement surface 122 may extend from the radially outward most portion of the first shoulder 104 in a direction generally radially outward from the longitudinal axis L₁₀₀ of the friction stir weld tool 100. As shown in FIG. 2 and more particularly in FIG. 3, in some embodiments the second shoulder 116 may be proximate the first shoulder 104. As used herein, the term “proximate” means adjacent to with no structure located therebetween.

In some embodiments, the engagement surface 122 of the second shoulder 116 may be coplanar with the friction surface 108 of the first shoulder 104. In other embodiments, the engagement surface 122 of the second shoulder 116 may be longitudinally recessed relative to the friction surface 108 of the first shoulder 104. In other words, the engagement surface 122 may be located longitudinally between the proximal end 106 of the shank 102 and the friction surface 108 of the first shoulder 104.

In a configuration similar to that of the friction surface 108 of the first shoulder 104, the engagement surface 122 of the second shoulder 116 may be substantially planar, as shown in FIGS. 2 and 3. However, in other embodiments, the engagement surface 122 may be non-planar. For example, the engagement surface 122 may curve generally radially outward and longitudinally upward. Additionally, the engagement surface 122 may include surface geometry, including but not limited to, beveled edges similar to the beveled edge 112 of the friction surface 108, recessed portions similar to the recessed portion 114 of the friction surface 108, and grooves so the engagement surface 122 forms a scroll shoulder as commonly known in the art.

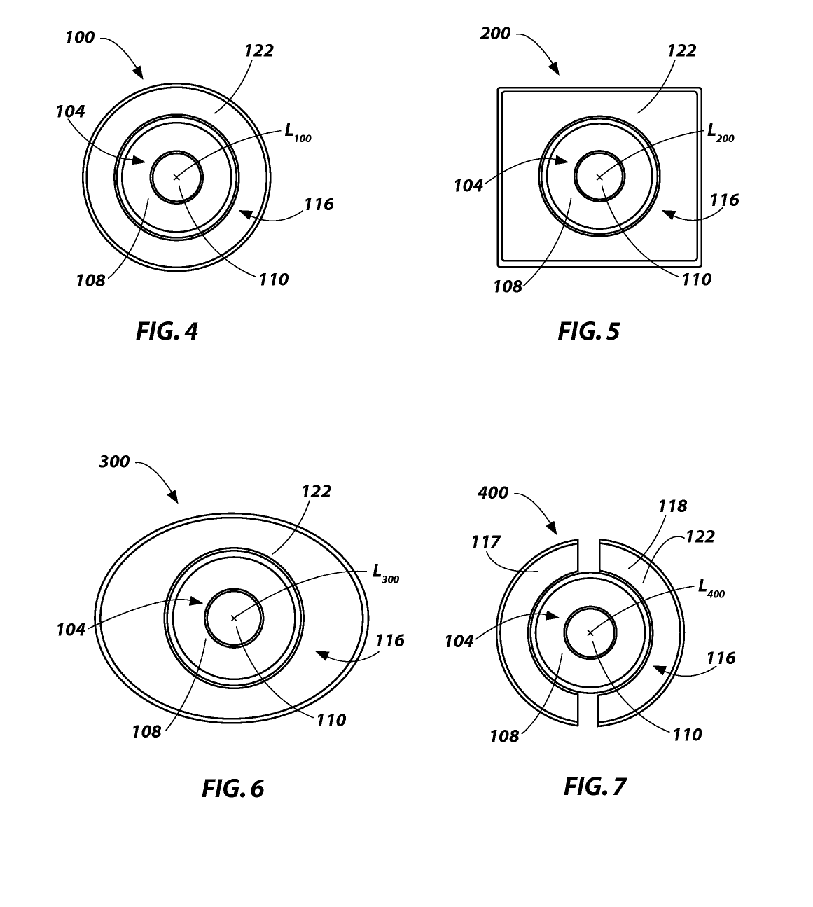

FIG. 4 is a plan view of the face of the friction stir weld tool 100 shown in FIGS. 2 and 3. As shown in FIG. 4, the engagement surface 122 of the second shoulder 116 may have a substantially circular shape. FIGS. 5, 6, and 7 are plan views like that of FIG. 4 illustrating three additional embodiments of friction stir weld tools 200, 300, 400 of the present invention. As shown in FIG. 5, the engagement surface 122 of the second shoulder 116 may have a substantially square shape or, as shown in FIG. 6, the engagement surface 122 of the second shoulder 116 may have a substantially elliptical shape. In additional embodiments, the engagement surface 122 of the second shoulder 116 may have an ovular, polygonal, or any other simple or complex shape.

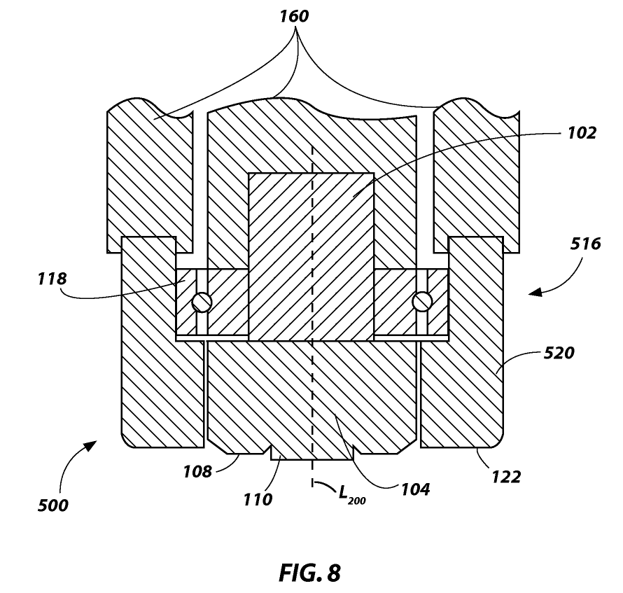

The second shoulder 116 may extend at least partially around the first shoulder 104. In some embodiments, the second shoulder 116 may extend completely around the first shoulder 104, as shown in FIG. 4. In other embodiments, as shown in FIG. 7, the second shoulder 116 may extend partially around the first shoulder 104. Additionally, the second shoulder 116 may comprise a single portion, as shown in FIG. 4, or may optionally comprise two or more portions 117, 118 secured at least partially around the first shoulder 104, as shown in FIG. 7.

As mentioned previously, the second shoulder 116 may be configured to enable the first shoulder 104 to rotate relative to the second shoulder 116. In some embodiments, the second shoulder 116 may be rotatably mounted to the first shoulder 104 by a bearing 118. Referring again to FIG. 3, the inner diameter of the bearing 118 may be mounted around the outer diameter of the first shoulder 104 and the collar 120 may be mounted around the outer diameter of the bearing 118. As shown in FIG. 3, the bearing 118 may comprise a ball bearing. In additional embodiments, the bearing 118 may comprise a roller bearing, thrust bearing, fluid bearing, or any other suitable type of bearing. As the second shoulder 116 may be rotatably mounted at least partially around the first shoulder 104, the first shoulder 104 and pin 110 may rotate relative to the second shoulder 116. In particular, the first shoulder 104 and the pin 110 may rotate within the second shoulder 116.

The second shoulder 116, the pin 110, and/or the first shoulder 104 may be formed from a metal or metal alloy. In some embodiments, the metal or metal alloy may be from the group comprising high temperature, high refractory metals such as tungsten, molybdenum, rhenium and their alloys. In other embodiments, one or more of such features may be formed from ceramics such as boron nitride, or from a tungsten carbide. In other embodiments, second shoulder 116, the pin 110, and/or the first shoulder 104 may be formed from an ANVILOY® 1150, or other tungsten based alloys. Other suitable materials for the second shoulder 116, the pin 110, and/or the first shoulder 104 may include Ti₃AlC₂, isotypic Ti₃SiC₂, Si₃N₄—SiC, CERamic-CERamic composites, and zirconium based alloys such as zircaloy.

In some embodiments, the second shoulder 116, the pin 110, and the first shoulder 104 may be formed from the same material. In other embodiments, second shoulder 116, the pin 110, and the first shoulder 104 may be formed from dissimilar materials.

FIG. 8 is a longitudinal cross sectional of another embodiment of friction stir weld tool 500 of the present invention. The friction stir weld tool 500 is similar to the friction stir weld tool 100 shown in FIGS. 2 and 3 and retains the same reference numerals for similar features. However, as shown in FIG. 8, the second shoulder 516 of the friction stir weld tool 500 and particularly the bearing 118 is secured to the shank 102 instead of the first shoulder 104. Additionally, the second shoulder 516 may be secured directly to a friction stir weld machine 160 and may be rotationally fixed relative to both the shank 102 and the first shoulder 104. In other words, as the friction stir weld machine 106 rotatably drives the shank 102, first shoulder 104, and pin 110, the second shoulder 516 may remain rotationally fixed. As with the friction stir weld tool 100, the first shoulder 104 and the pin 110 may rotate relative to the second shoulder 516. In particular, the first shoulder 104 and the pin 110 may rotate within the second shoulder 516.

Furthermore, the second shoulder 516 and the engagement surface 122 of the second shoulder 516 may be configured such that a plan view of the friction stir weld tool 500 appears substantially similar to FIG. 4, 5, 6, or 7.

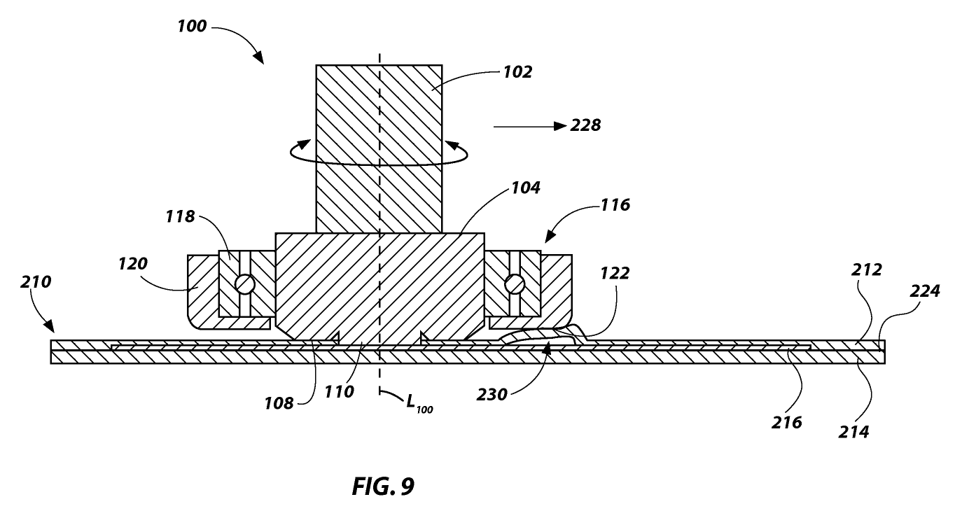

An embodiment of a method of using the friction stir weld tools 100, 200, 300, 400, 500 of the present invention to bond thin sheets is described below in relation to FIG. 9. The method is described in relation to the friction stir weld tool 100 shown in FIGS. 2 and 3 but may be used with any of the friction stir weld tools of the present invention. FIG. 9 illustrates a method of the present invention that may be used to form a monolithic fuel plate 210 by bonding a fuel foil 216 between two thin metal sheets 212, 214. However, the methods as described in the following embodiment are not so limited and may be used to bond or laminate any number of thin sheets formed of metal, polymers, or any other material suitable for use with friction stir welding.

A conventional friction stir welding machine (not shown) may be used to plunge the pin 110 of the friction stir weld tool 100 into a major surface of the upper thin metal sheet 212 until the friction surface 122 rests on the surface of the upper thin metal sheet 212. The friction stir welding machine may rotatably drive the shank 102 of the friction stir weld tool 100 about the longitudinal axis L₁₀₀. As the shank 102 is rotated, the pin 110 and the first shoulder 104 are also rotated about the longitudinal axis L₁₀₀. In the embodiments where the second shoulder 116 is rotatable, the second shoulder 116 may also rotate in unison with the first shoulder 104.

The heat and pressure created by the mechanical friction of the rotating tool 100 plasticizes (softens) the metal in the region near the pin 110. As shown, the friction stir weld tool 100 is moved in a direction 228 along the surface of the upper sheet 212 over the interface 224 between the sheets 212, 214 and the fuel foil 216 to create a region of plasticized material. In other embodiments, the workpiece may be moved relative to the friction stir weld tool 100. As the pin 110 rotates and is moved along the interface 224, the metal near the front of the pin 110 is plasticized and extruded behind the pin 110 while undergoing a mechanical stirring and forging action caused by the pin surface profile and confined from above by the pressure exerted on the upper thin metal sheet 212 by the first shoulder 104. As shown, the pin 110 may not extend into the interface 224 and instead may be offset from the interface 224 to avoid the fuel foil 216 from being stirred into the upper thin metal sheet 212.

Furthermore, when a region 230 of the thin metal sheet 212 begins to warp or buckle due to the heat and pressure created by the pin 110 and the first shoulder 104, the region 230 may engage the engagement surface 122 of the second shoulder 116. When the engagement surface 122 makes contact the warping or buckling region 230 of the thin metal sheet 212, the second shoulder 116 may stop rotating and suppress the warping of the thin metal sheet 212. Furthermore, the second shoulder 116 may hold the thin metal sheet 212 flat to enable the thin metal sheet 212 to be bonded to the fuel foil 216 without tearing the thin metal sheet 212 as the first shoulder 104 passes over it. Furthermore, by holding the thin metal sheet 212 flat, the second shoulder 116 may additionally ensure that the bond between the thin metal sheet 212 and the fuel foil 216 and the bond between the thin metal sheets 212, 214 are consistent throughout the fuel plate 210.

By longitudinally recessing the engagement surface 122 relative to the friction surface 108, it is ensured that the engagement surface 122 does not contact the thin metal sheet 212 unless it begins to warp or buckle. Furthermore, by longitudinally recessing the engagement surface 122 it is ensured that the engagement surface 122 does not score the thin metal sheet 212 or add additional heat or pressure to the workpiece being bonded.

Therefore, the friction stir weld tools of the present invention may provide advantages over conventional friction stir weld tools. In particular, the friction stir weld tools of the present invention may enable the bonding or laminating of thin sheets without warping, buckling, or tearing the sheets, and without surface damage necessitating further processing. Furthermore, the friction stir weld tools of the present invention may provide consistent bond quality between thin sheets of dissimilar material and enable the production of bonding or laminating of thin sheets that are flat and parallel.

While the present invention has been described herein with respect to certain preferred embodiments, those of ordinary skill in the art will recognize and appreciate that it is not so limited. Rather, many additions, deletions and modifications to the preferred embodiments may be made without departing from the scope of the invention as hereinafter claimed. In addition, features from one embodiment may be combined with features of another embodiment while still being encompassed within the scope of the inventions encompassed by the claims which follow and their legal equivalents.

What is claimed is:

1. A friction stir weld tool, comprising:
a first shoulder;
a pin extending from a friction surface of the first shoulder; and
a second shoulder secured at least partially around the first shoulder, the second shoulder comprising an engagement surface longitudinally recessed with respect to the friction surface of the first shoulder.

2. The friction stir weld tool of claim 1, wherein the first shoulder is configured to rotate relative to the second shoulder.

3. The friction stir weld tool of claim 2, wherein the second shoulder is secured to the first shoulder by a bearing.

4. The friction stir weld tool of claim 1, wherein the second shoulder it rotatably fixed.

5. The friction stir weld tool of claim 4, wherein the second shoulder is securable directly to a portion of a friction stir weld machine.

6. The friction stir weld tool of claim 1, wherein the first and second shoulders are formed from a high-temperature refractory material.

7. The friction stir weld tool of claim 6, wherein the first and second shoulders are formed from a material selected from the group consisting of ANVILOY® 1150, boron nitride, tungsten carbide, a tungsten alloy, a zirconium alloy, Ti₃AlC₂, isotypic Ti₃SiC₂, Si₃N₄—SiC, and CERamic-CERamic composites.

8. The friction stir weld tool of claim 1, wherein the engagement surface comprises a generally circular cross section.

9. The friction stir weld tool of claim 1, wherein the second shoulder comprises two portions mounted at least partially around the first shoulder.

10. A friction stir weld tool, comprising:
a first shoulder;
a pin extending from a friction surface of the first shoulder; and
a second shoulder proximate the first shoulder, wherein the second shoulder is rotationally fixed.

11. The friction stir weld tool of claim 10, wherein the second shoulder comprises an engagement surface with a generally circular cross section.

12. The friction stir weld tool of claim 10, wherein the second shoulder is longitudinally recessed relative to the first shoulder.

13. A friction stir weld tool, comprising:
a first shoulder;
a pin extending from a friction surface of the first shoulder, wherein a diameter of the pin is greater than a height of the pin; and
a second shoulder secured at least partially around the first shoulder.

14. The friction stir weld tool of claim 13, wherein the first shoulder is rotatable relative to the second shoulder.

15. The friction stir weld tool of claim 13, wherein an engagement surface of the second shoulder is longitudinally recessed relative to the friction surface of the first shoulder.

16. A method of manufacturing a friction stir weld tool, comprising:
providing a first shoulder;
securing a second shoulder at least partially around the first shoulder; and
longitudinally recessing the second shoulder along a longitudinal axis of the friction stir weld tool relative to the first shoulder.

17. The method of claim 16, further comprising:
configuring the first shoulder to be rotatable relative to the second shoulder.

18. The method of claim 16, further comprising disposing a bearing between the first and second shoulders.

19. The method of claim 16, further comprising securing the first shoulder proximate the second shoulder.

20. A method of friction stir welding, comprising:
at least partially overlapping a first thin sheet and at least a second thin sheet;
inserting a pin of a friction stir weld tool into a surface of the first thin sheet;
abutting a first shoulder of the friction stir weld tool against the surface of the first thin sheet with a second shoulder thereof offset therefrom;
rotationally driving the friction stir weld tool along an interface between the first thin sheet and the at least a second thin sheet; and
causing the second shoulder to first contact at least a portion of the first thin sheet when the at least a portion of the first thin sheet begins to warp.

21. The method of claim 20, wherein causing the second shoulder to first contact at least a portion of the first thin sheet further comprises causing the second shoulder to stop rotating.

22. The method of claim 20, wherein causing the second shoulder to first contact at least a portion of the first thin sheet further comprises suppressing warping of the first thin sheet.

23. The method of claim 20, wherein at least partially overlapping a first thin sheet and at least a second thin sheet comprises at least partially overlapping a first thin sheet comprising a first material and at least a second thin sheet comprising a material differing from the first material.

24. The method of claim 20, wherein at least partially overlapping a first thin sheet and at least a second thin sheet comprises overlapping a first thin sheet and at least a second thin sheet formed from aluminum or an alloy thereof.
